(19) United States
(12) Patent Application Publication
(10) Pub. No.: US 2020/0408553 A1
(43) Pub. Date: Dec. 31, 2020

(54) ROUTE INFORMATION TRANSMISSION METHOD, ROUTE INFORMATION TRANSMISSION SYSTEM, AND IN-VEHICLE TERMINAL

(71) Applicant: Clarion Co., Ltd., Saitama-shi, Saitama (JP)

(72) Inventors: Takashi MATSUMOTO, Tokyo (JP); Mitsunori MARU, Tokyo (JP); Tsuyoshi HANO, Saitama-shi (JP)

(21) Appl. No.: 16/978,640

(22) PCT Filed: Dec. 18, 2018
(86) PCT No.: PCT/JP2018/046614

§ 371 Date: Sep. 4, 2020

(30) Foreign Application Priority Data
Mar. 6, 2018 (JP) 2018-040035

(51) Int. Cl. G01C 21/36; G01C 21/34; G01C 21/00

(52) U.S. Cl. CPC G01C 21/36; G01C 21/3885; G01C 21/3407

(57) ABSTRACT

A route information transmission method is a route information transmission method including: calculating the driving route of a vehicle from an origin to a destination; extracting combinations of latitudes and longitudes from the calculated driving route; and transmitting the extracted combinations of latitudes and longitudes to the vehicle.

### TECHNICAL FIELD

The present invention relates to a route information transmission method, a route information transmission system, and an in-vehicle terminal.

### BACKGROUND ART

A main object of a car navigation system is to determine a current position of a vehicle and display a route to a destination, and provide route navigation from the current position to the destination. The widespread use of communication terminals such as a smartphone widely provides searches for destinations or travel routes outside vehicles by means of map applications. PTL 1 discloses a service provision system including at least: a navigation apparatus that is mounted with a radio-communication terminal function in a mobile unit and is assigned with a specific apparatus ID; a service server that has a predetermined service providing function and stores the apparatus IDs of the navigation apparatuses capable of providing service; a personal terminal apparatus, at least one communication network that enables communications between the navigation apparatus and the service server and communications between the service server and the personal terminal apparatus, the service provision system further including: access means for access from the personal terminal apparatus to the service server through the communication network; control information generation means that generates at least control information for controlling the operation of the navigation apparatus, which is assumed to correspond to the personal terminal apparatus, and stores the information in the service server in response to an operation performed on the personal terminal apparatus while the personal terminal apparatus accesses the service server; transmission means that accesses the specific one of the navigation apparatuses from the service server by using the apparatus ID and transmits the control information to the navigation apparatus accessed by the transmission means; and control means that controls the navigation apparatus so as to perform a predetermined operation based on the contents of the received control information.

### CITATION LIST

### Patent Literature

### [PTL 1] Japanese Patent Application Publication No. 2002-48558

### SUMMARY OF INVENTION

### Technical Problem

According to the invention described in PTL 1, an in-vehicle terminal cannot replicate a route searched for by a server if the route searching method of the server is different from that of the in-vehicle terminal.

### Solution to Problem

A route information transmission method according to a first aspect of the present invention is a route information transmission method performed by a server, the method including: calculating the driving route of a vehicle from an origin to a destination; extracting combinations of latitudes and longitudes from the calculated driving route; and transmitting the extracted combinations of latitudes and longitudes to the vehicle.

A route information transmission system according to a second aspect of the present invention is a route information transmission system including a server and an in-vehicle terminal that is installed in a vehicle and communicates with the server, the server including a map search unit that calculates the driving route of the vehicle from an origin to a destination; an external-map-mode data generation unit that generates external-map mode data including combinations of latitudes and longitudes from the calculated driving route, and a server communication unit that transmits the external-map mode data to the in-vehicle terminal. The in-vehicle terminal includes a communication unit that receives the external-map mode data; and an external-map-mode search unit that calculates a route from the origin to the destination via a plurality of points specified by the combinations of latitudes and longitudes in the external-map mode data.

An in-vehicle terminal according to a third aspect of the present invention is an in-vehicle terminal for receiving combinations of latitudes and longitudes that are transmitted by the method, the in-vehicle terminal being installed in the vehicle, the in-vehicle terminal including: a storage unit that stores a map database used for a route search: and an external-map-mode search unit that calculates, with reference to the map database, a route from the origin to the destination via a plurality of points specified by the combinations of latitudes and longitudes.

### Advantageous Effects of Invention

According to the present invention, an in-vehicle terminal cannot replicate a route searched for by a server if the route searching method of the server is different from that of the in-vehicle terminal.

### BRIEF DESCRIPTION OF DRAWINGS

FIG. 1 is an overall block diagram of a route information transmission system S according to a first embodiment.

FIG. 2 is a hardware block diagram of an in-vehicle terminal 10.

FIG. 3 is a hardware block diagram of a communication terminal 20.

FIG. 4 is a hardware block diagram of a server 30.

FIG. 5 is a functional block diagram of the server 30.

FIG. 6 is a functional block diagram of the in-vehicle terminal 10.

FIG. 7 is a schematic diagram of a map DB 550.

FIG. 8(a) illustrates a visualized driving route P of a vehicle 40 and FIG. 8(b) illustrates the driving route P divided by a minimum mesh M.

FIG. 9 is a flowchart showing the operations of an external-map processing unit 400 according to the first embodiment.

FIG. 10 is a flowchart showing the operations of a navigation unit 500.

FIG. 11 is an explanatory drawing of the operation of an external-map-mode data generation unit 440 according to modification 1.

FIG. 12 is an explanatory drawing of the operation of the external-map-mode data generation unit 440 according to modification 2.

FIG. 13 is a flowchart showing the operations of a navigation unit 500 of an in-vehicle terminal 10 according to a second embodiment.

FIG. 14 is a flowchart showing the operations of a navigation unit 500 of an in-vehicle terminal 10 according to a third embodiment.

FIG. 15 illustrates the functional configuration of a server 30 according to a fourth embodiment.

FIG. 16 illustrates the functional configuration of an in-vehicle terminal 10 according to the fourth embodiment.

FIG. 17 is a flowchart showing the operations of an external-map processing unit 400 of the server 30 according to the fourth embodiment.

FIG. 18 is a flowchart showing the operations of a navigation unit 500 of the in-vehicle terminal 10 according to the fourth embodiment.

FIG. 19 is a functional block diagram of a communication terminal 20 according to a fifth embodiment.

FIG. 20 is a functional block diagram of a communication terminal 20 according to a sixth embodiment.

FIG. 21 illustrates a search result presented to a user.

### DESCRIPTION OF EMBODIMENTS

### First Embodiment

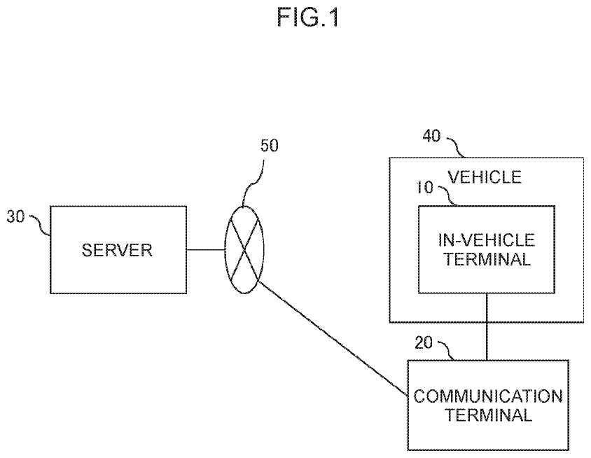

Referring to FIGS. 1 to 10 and 21, a first embodiment of a route information transmission system of the present invention will be described below.

(System Configuration)

FIG. 1 is an overall block diagram of a route information transmission system S according to the first embodiment. The route information transmission system S includes an in-vehicle terminal 10 that is mounted in a vehicle 40, a communication terminal 20, a server 30, and the vehicle 40. The communication terminal 20 and the server 30 are coupled to each other via a communication network 50.

The in-vehicle terminal 10 communicates with the server 30 via the communication terminal 20. However, the in-vehicle terminal 10 may bypass the communication terminal 20 and communicate with the server 30. In this case, a wireless LAN access point outside the vehicle or a radio communication module provided for 3G or 4G in the vehicle 40 is used.

The communication terminal 20 is coupled to the server 30 via the communication network 50 and transmits and receives information to and from the in-vehicle terminal 10 and the server 30. The information is necessary for providing a navigation function. The in-vehicle terminal 10 and the communication terminal 20 are coupled by using communication standards such as USB (Universal Serial Bus), Bluetooth (registered trademark), and wireless LAN.

The server 30 is coupled to the communication terminal 20 via the communication network 50 and transmits information for performing the navigation function to the in-vehicle terminal 10. The communication network 50 is a network that can be coupled to computers and terminals on a telephone network or the Internet.

(Hardware Configuration of in-Vehicle Terminal 10)

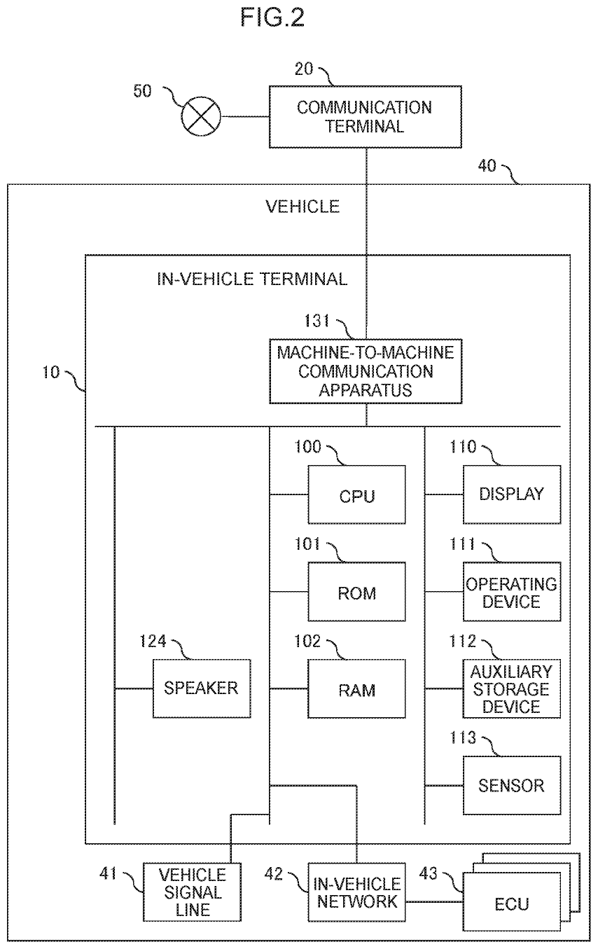

FIG. 2 is a hardware block diagram of the in-vehicle terminal 10. The in-vehicle terminal 10 includes a CPU 100, a central processing unit, a ROM 101 that is a storage for reading only, a RAM 102 that is a readable storage, a display 110, an operating device 111, an auxiliary storage device 112, a sensor 113, a speaker 124, and a machine-to-machine communication apparatus 131.

The CPU 100 develops a program, which is stored in the ROM 101, on the RAM 102 and executes the program so as to perform functions as will be described later. In the ROM 101, the program executed by the CPU 100 is stored. The display 110 is, for example, a liquid crystal display or an organic EL (Electro-Luminescence) display. The display 110 displays information based on an operation command from the CPU 100 so as to inform a passenger (hereinafter, will be referred to as “user”) of the vehicle 40 about the information. The operating device 111 is a button, a switch, or a keyboard. The operating device 111 is operated by a user. Information on the user operation of the operating device 111 is transmitted to the CPU 100. The operating device 111 and the display 110 may be integrated into, for example, a touch panel mounted on the in-vehicle terminal 10.

The auxiliary storage device 112 is a nonvolatile storage, for example, an HDD (Hard Disk Drive) or an SSD (Solid State Drive). In the auxiliary storage device 112, for example, map data used for calculating a route and a setting film used by the program are stored. The map data and the setting file that are stored in the auxiliary storage device 112 may be updated based on update information received from the server 30, which will not be described in the present embodiment. The sensor 113 is hardware including a GPS receiver and an angle meter. The GPS receiver receives radio waves from a plurality of satellites constituting a global positioning system and calculates the position of the vehicle 40, that is, the latitude and longitude of the vehicle 40 by analyzing a signal included in the radio waves. The angle meter calculates the yaw angle of the vehicle 40, that is, the traveling direction.

The speaker 124 outputs, for example, voice guidance and operation sound during route guidance and reproduced music information. The machine-to-machine communication apparatus 131 is an interface apparatus that is coupled to the communication terminal 20 and exchanges data with the communication terminal 20. The machine-to-machine communication apparatus 131 may be an apparatus for wired coupling compliant with standards such as USB and HDMI (High-Definition Multimedia Interface) (registered trademark) or an apparatus for wireless coupling compliant with standards such as wireless LAN and Bluetooth.

The in-vehicle terminal 10 is coupled to the vehicle 40 via a vehicle signal line 41 and an in-vehicle network 42 and retrieves information on the internal state of the vehicle 40, the information including the speed of the vehicle 40, the steering angle of the steering wheel, the position of the shift lever, and the state of the parking brake. An ECU (Electronic Control Unit) 43 is a unit for controlling the apparatuses and a system (including an engine, a brake, steering, a meter, and an obstacle sensor) in the vehicle 40.

(Hardware Configuration of Communication Terminal 20)

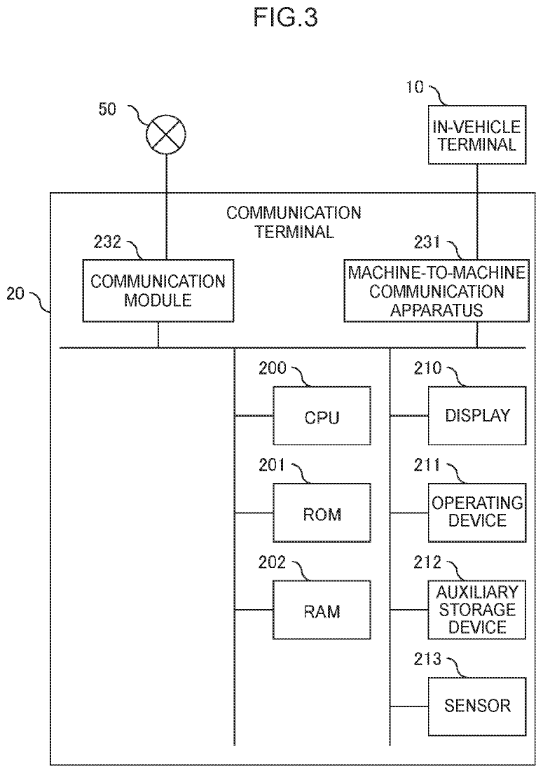

FIG. 3 is a hardware block diagram of the communication terminal 20. The communication terminal 20 includes a CPU 200, a ROM 201, a RAM 202, a display 210, an operating device 211, an auxiliary storage device 212, a sensor 213, a communication module 232, and a machine-to-machine communication apparatus 231. The CPU 200 develops a program, which is stored in the ROM 201, on the RAM 202 and executes the program so as to perform functions as will be described later.

In the ROM 201, the program executed by the CPU 200 is stored. The display 210 is, for example, a liquid crystal display or an organic EL display. The display 210 displays information based on an operation command from the CPU 200 so as to inform the user about the information. The operating device 211 is a button, a switch, or a keyboard. The operating device 211 is operated by the user. Information on the user operation of the operating device 211 is transmitted to the CPU 200. The operating device 211 and the display 210 may be integrated into, for example, a touch panel mounted on the communication terminal 20.

The auxiliary storage device 212 is a nonvolatile storage, for example, a flash memory. The communication module 232 is, for example, a communication module for 3G or 4G. The communication module 232 conducts radio communications with a base station located within several kilometers and is coupled to the communication network 50 via the base station. The machine-to-machine communication apparatus 231 communicates with the machine-to-machine communication apparatus 131 installed in the in-vehicle terminal 10. The configuration of the machine-to-machine communication apparatus 231 is similar to that of the machine-to-machine communication apparatus 131 and thus an explanation thereof is omitted.

(Hardware Configuration of Server 30)

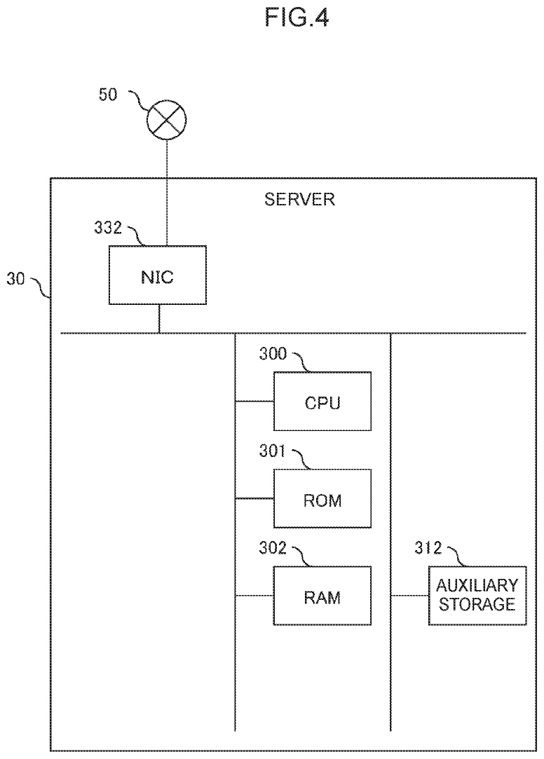

FIG. 4 is a hardware block diagram of the server 30. The server 30 includes a CPU 300, a ROM 301, a RAM 302, an NIC (Network Interface Card) 332, and an auxiliary storage device 312. The CPU 300 develops a program, which is stored in the ROM 301, on the RAM 302 and executes the program so as to perform functions as will be described later. In the ROM 301, the program executed by the CPU 300 is stored. The NIC 332 communicates with the in-vehicle terminal 10 via the communication network 50 and the communication terminal 20. The auxiliary storage device 312 is, for example, an HDD.

(Functional Configuration of Server 30)

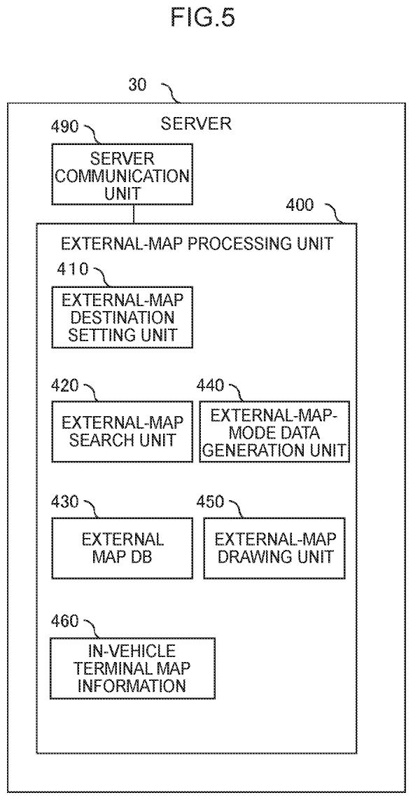

FIG. 5 is a functional block diagram of the server 30. The server 30 has, as functions, a server communication unit 490 and an external-map processing unit 400. The server communication unit 490 is implemented by a server communication apparatus 332 and the external-map processing unit 400 is implemented by the program executed by the CPU 300. The external-map processing unit 400 includes an external-map destination setting unit 410, an external-map search unit 420, an external-map database (hereinafter, will be referred to as “external map DB”) 430, an external-map-mode data generation unit 440, an external-map drawing unit 450, and in-vehicle terminal map information 460. The external map DB 430 and the in-vehicle terminal map information 460 are information stored in advance in the auxiliary storage device 312. In the present embodiment, the map information stored in the server 30 is external map information with respect to the vehicle 40 and thus will be referred to as “external map”.

The external-map destination setting unit 410 communicates with the user in an interactive mode and sets an origin, a destination, and a route from the origin to the destination in the external-map processing unit 400 based on a user's choice. The origin and the destination may be specified by the user or may be determined by the user by using the POI search function of the external-map destination setting unit 410. If the POI search function is used, the external-map destination setting unit 410 searches the external map DB 430 based on a search condition set by the user and informs the user of POI information corresponding to the condition. When the origin and the destination are set, the external-map search unit 420 is caused to search for a route. At this point, the user may select a search condition of the route, for example, a minimum time or a minimum traveled distance. If a plurality of routes are available, one of the routes may be selected by the user. When the route is determined, the external-map destination setting unit 410 prepares external-map mode data by using the external-map-mode data generation unit 440 and transmits the data to the in-vehicle terminal 10 via the server communication unit 490.

The external map DB 430 is a map database provided in the server 30. In the external map DB 430, map information necessary for a POI search and a route search is stored. The map information in the present embodiment includes information on a link and a node that constitute a road, information for map drawing, POI latitude/longitude coordinates, detailed information on a POI, the width of the road, and regulation information on the road. Each link includes information the latitudes and longitudes of both ends of the link, a link length, a link shape, and a link number for specifying the link in the external map DB 430. The link shape may be expressed by a formula or the latitudes and longitudes of a plurality of points on the link.

The external-map search unit 420 refers to the external-map database 430 and searches for a route to the POI or the latitude/longitude coordinates of a destination from the POI or the latitude/longitude coordinates of an origin specified by the user. The external-map search unit 420 can search for a route by using various existing methods. The server 30 can use a larger resource for computing than the communication terminal 20. This enables, for example, a route search actively using narrow streets. Such a route search is not ordinarily conducted by the in-vehicle terminal 10 and the communication terminal 20. The route search results of the external-map search unit 420 can be outputted in various forms.

For example, the external-map search unit 420 can output combinations of latitudes and longitudes at predetermined spacings, for example, every one meter or 100 meters on a route determined by a search. Moreover, the external-map search unit 420 can output the link numbers of links where the vehicle 40 passes during driving from an origin to a destination, as a sequence of link numbers arranged in the order in which the vehicle 40 passes.

The external-map-mode data generation unit 440 processes the route search result of the external-map search unit 420 and generates data usable by the in-vehicle terminal 10, that is, external-map mode data. The external-map mode data includes combinations of latitudes and longitudes that are extracted from a route from an origin to a destination, specifically, data in KML format or the like. The combinations of latitudes and longitudes may be regarded as via points in the passage from the origin to the destination. The combinations of latitudes and longitudes in the external-map mode data also include order information so as to specify the order of passage of the vehicle 40. Alternatively, the combinations of latitudes and longitudes may be stored in the order of passage without specifying the order information.

The in-vehicle terminal map information 460 is information on the division and storage of map information in a map database 550 stored in the in-vehicle terminal 10. The map database 550 will be described later. Specifically, the in-vehicle terminal map information 460 includes information on the length of a side of the most detailed map in the map DB 550 and information on the reference position of the map.

(Functional Configuration of in-Vehicle Terminal 10)

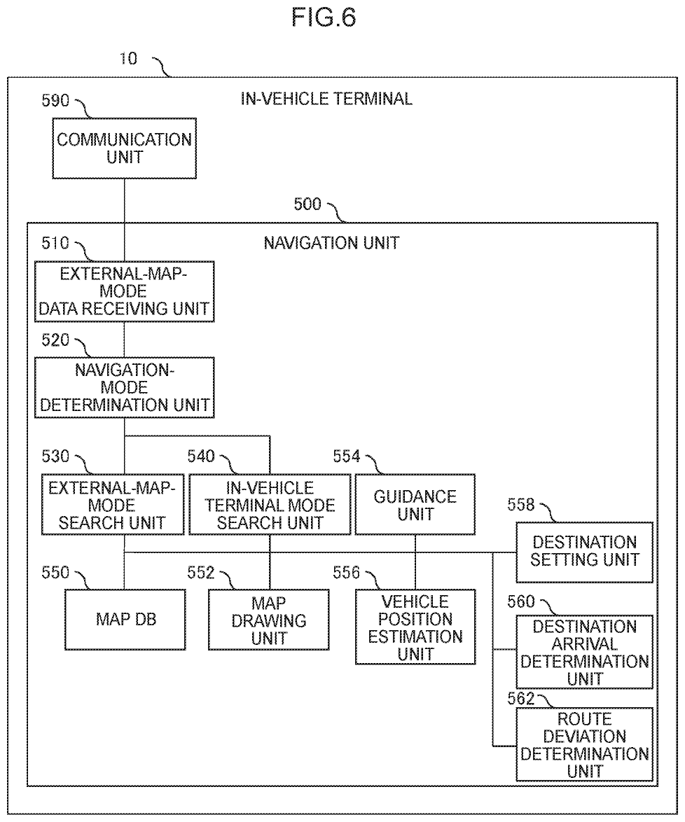

FIG. 6 is a functional block diagram of the in-vehicle terminal 10. The in-vehicle terminal 10 includes a communication unit 590 and a navigation unit 500 as functions. The communication unit 590 is implemented by the machine-to-machine communication apparatus 131 and the navigation unit 500 is implemented by the program executed by the CPU 200.

The navigation unit 500 includes an external-map-mode data receiving unit 510, a navigation-mode determination unit 520, an external-map-mode search unit 530, an in-vehicle terminal mode search unit 540, the map database (hereinafter, will be referred to as “map DB”) 550, a map drawing unit 552, a guidance unit 554, a vehicle position estimation unit 556, a destination setting unit 558, a destination arrival determination unit 560, and a route deviation determination unit 562. The map database 550 is information stored in advance in the auxiliary storage device 112.

The external-map-mode data receiving unit 510 receives external-map mode data from the server 30. The navigation-mode determination unit 520 determines which one of the external-map-mode search unit 530 and the in-vehicle terminal mode search unit 540 is to be used for a route search. The external-map-mode search unit 530 searches for a route by using the external-map mode data acquired from the server 30. The in-vehicle terminal mode search unit 540 enables a route search by the in-vehicle terminal 10 alone. The map DB 550 is a map database provided in the in-vehicle terminal 10 and used for the POI and a route search. In the map DB 550, road information and POI information are stored while being divided among the locations. The database will be specifically described below.

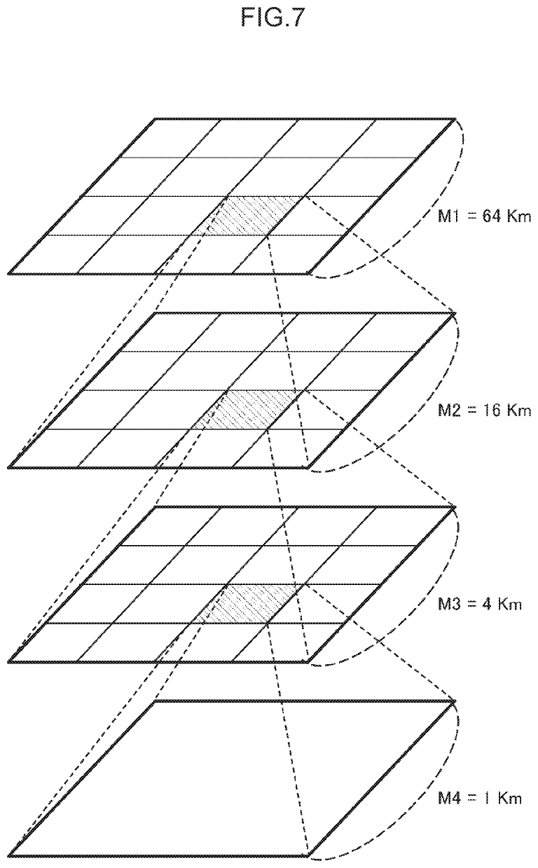

FIG. 7 is a schematic diagram of the map DB 550. In the map DB 550, quite a wide range of map information is stored. The map DB 550 includes map information with different scales such that optimum information can be used for an application purpose. In this case, the map database 550 includes maps with four scales: M1 tier to M4 tier. For example, the M1 tier map including the maximum range of information has a side equivalent to 64 km. The M2 tier map is obtained by dividing the M1 tier map into meshes, for example, four along each side that measures 16 km. The M2 tier map includes information on an area one-sixteenth the area of the M1 tier. Similarly, the M3 tier may is obtained by dividing the M2 tier map into four along each side that measures 4 km and the M4 tier map includes information obtained by diving the M3 tier map into four along each side that measures 1 km.

The M1 tier map includes coarse information over a wide range, whereas the M4 tier map includes local and minute information. For example, information on wide roads such as a highway is included on both of the M1 tier and the M4 tier and information on narrow roads such as a minor street is not included in the M1 tier. The information may be stored in the external map DB 430 in any format and thus the road information and POI information to be stored may not be divided among the locations unlike in the map DB 550.

Referring to the map database 550, the map drawing unit 552 generates detailed information on the map of locations specified by the user and the POI, route information searched for by the external-map-mode search unit 530 or the in-vehicle terminal mode search unit 540, and information for displaying, for example, the current position of a user's vehicle, the current position being stored in the vehicle position estimation unit 556. The guidance unit 554 displays the route information, which has been searched for by the external-map-mode search unit 530 or the in-vehicle terminal mode search unit 540, on the display 110 and guides the user to a destination.

The vehicle position estimation unit 556 estimates the current position of the vehicle 40 by using, for example, information from the sensor 113 of the in-vehicle terminal 10 and the vehicle signal line 41 and the in-vehicle network 42 of the vehicle 40 and latitude/longitude coordinate information on roads in the map database 550. The destination setting unit 558 displays the POI information or the search result of a route to the POI on the display 110. The destination setting unit 558 sets the latitude/longitude coordinates of a location specified by the user or the POI, as a destination in the navigation unit 500.

The destination arrival determination unit 560 determines whether the vehicle has reached the destination or not based on the destination set by the destination setting unit 558 and the information of the vehicle position estimation unit 556. The route deviation determination unit 562 determines whether the position of the vehicle 40 has deviated from a route searched for by the external-map-mode search unit 530 or the in-vehicle terminal mode search unit 540 based on the information of the vehicle position estimation unit 556.

(Operation of External-Map-Mode Data Generation Unit 440)

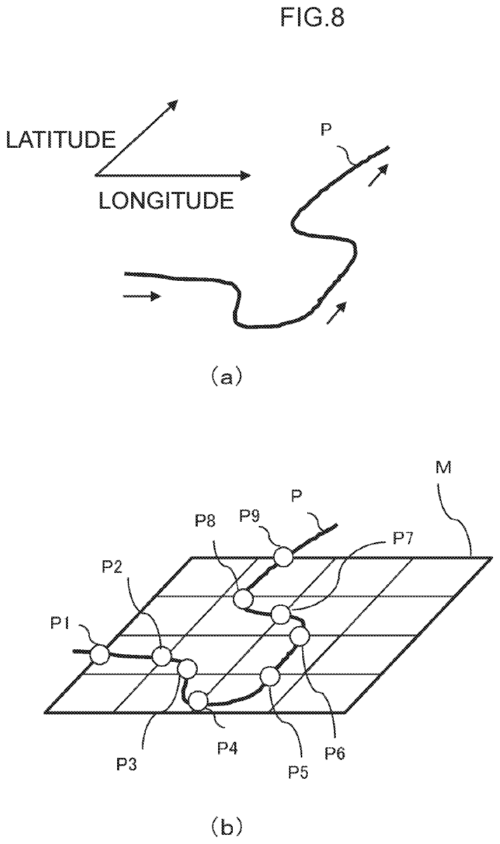

The external-map-mode data generation unit 440 extracts combinations of latitudes and longitudes from the route search results of the external-map search unit 420, that is, the driving route of the vehicle 40 based on the in-vehicle terminal map information 460. The conceptual operation of the external-map-mode data generation unit 440 will be described below with reference to the drawings. The operation of the external-map-mode data generation unit 440 in FIG. 8 is visually illustrated for explanation. In reality, the following image generation is not always necessary.

FIG. 8 illustrates schematic diagrams for explaining the operation of the external-map-mode data generation unit 440. FIG. 8(a) illustrates a visualized driving route P of the vehicle 40. FIG. 8(b) illustrates the driving route P divided by a minimum mesh M. Arrows in FIG. 8(a) indicate that the vehicle 40 travels from the left to the top on the driving route P.

The external-map-mode data generation unit 440 first draws the overall determined route by using the output of the external-map search unit 420 and the external map DB 430. Specifically, the external-map-mode data generation unit 440 draws the driving route P of the vehicle 40 as the determined route on a plane where latitudes and longitudes are defined as illustrated in FIG. 8(a), for example, on a map. The external-map search unit 420 outputs the determined route as a sequence of link numbers, so that the link numbers are sequentially read from the head of the sequence and the positions and shapes of the links are specified with reference to the external map DB 430. If the external-map search unit 420 outputs combinations of latitudes and longitudes, the external-map-mode data generation unit 440 can draw the overall determined route without referring to the external map DB 430.

Subsequently, the external-map-mode data generation unit 440 reads the in-vehicle terminal map information 460, acquires the normal coordinates and the mesh size of the most detailed map in the map DB 550 of the in-vehicle terminal 10, and draws the superimposed minimum mesh M with the driving route P. The external-map-mode data generation unit 440 then extracts the coordinates of the intersection points of the driving route P and the minimum mesh M (hereinafter, will be referred to as “route characteristic points”) in the order in which the vehicle 40 travels. For example, the coordinates of route characteristic points P1 to P9 are sequentially extracted in the example of FIG. 8(b). In other words, the external-map mode data includes the coordinates of the route characteristic points to which order information is added.

As described above, the external-map-mode data generation unit 440 conceptually operates. Actually, the external-map-mode data generation unit 440 may not visualize the driving route P as illustrated in FIG. 8 and the route characteristic points may be determined only by computing.

(Operation of External-Map-Mode Search Unit 530)

The external-map-mode search unit 530 searches for a route by using the M4 tier map in the map DB 550 and the external-map mode data as will be described below. As described above, the external-map mode data includes the coordinates of the route characteristic points to which the order information is added, enabling the external-map-mode search unit 530 to specify the first route characteristic point from the route characteristic points included in the external-map mode data. The external-map-mode search unit 530 first specifies an origin. The origin may be included in the external-map mode data, may be transmitted from the server 30 in addition to the external-map mode data, or may be inputted to the in-vehicle terminal 10 by the user.

The external-map-mode search unit 530 then specifies the M4 tier map including the origin and the first route characteristic point, and searches for a route from the origin to the first route characteristic point by using the map. Subsequently, the external-map-mode search unit 530 specifies the M4 tier map including the first and second route characteristic points and searches for a route from the first route characteristic point to the second route characteristic point by using the map. Thereafter, the external-map-mode search unit 530 searches for routes connecting the route characteristic points by using the M4 tier map, leading to a route search to a destination. The external-map-mode search unit 530 then connects all the routes, completing the calculation of a route from the origin to the destination, that is, the driving route of the vehicle 40.

(Flowcharts of Route Information Transmission System S)

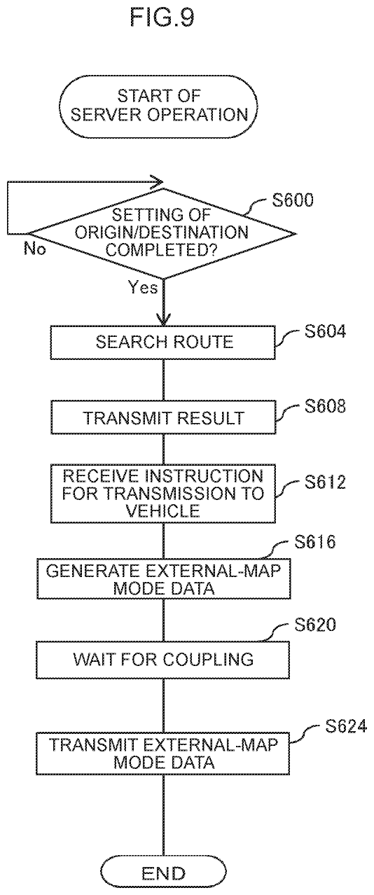

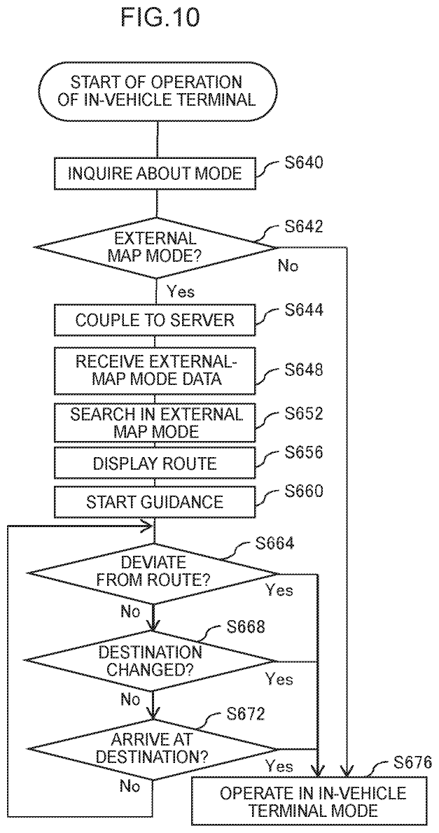

Referring to FIGS. 9 and 10, flowcharts showing the operations of the route information transmission system S will be described below. FIG. 9 is a flowchart showing the operations of the external-map processing unit 400 of the server 30. FIG. 10 is a flowchart showing the operations of the navigation unit 500 of the in-vehicle terminal 10.

In the following processing, the series of processing starts when the user accesses the server 30 by using the communication terminal 20 or a personal computer and sets an origin and a destination by using the external-map destination setting unit 410. However, an explicit user access to the server 30 is not always necessary. For example, an application installed on the communication terminal 20 may communicate with the server 30 based on a user operation and set an origin and a destination. Alternatively, an origin may be set at the current position of the vehicle 40 without being specified by the user.

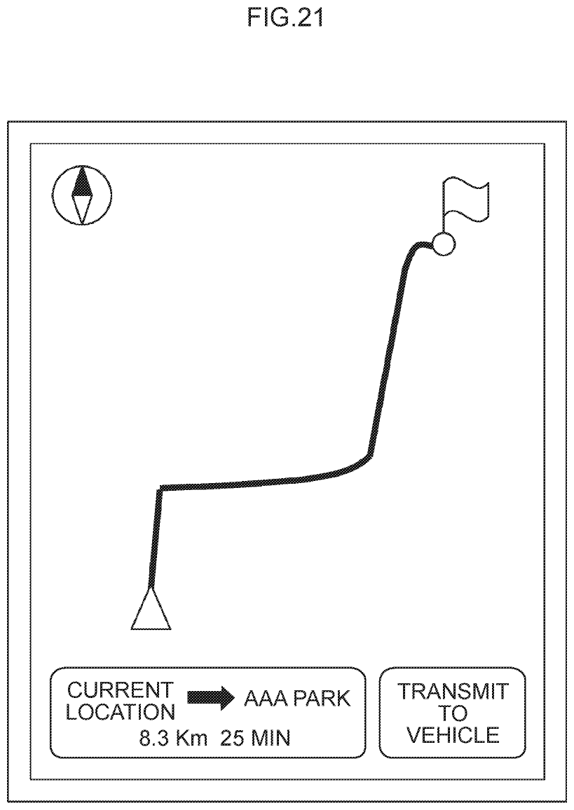

As indicated in FIG. 9, the server 30 first determines whether the setting of an origin and a destination has been completed or not (S600). If the server 30 determines that the setting has been completed, the process advances to S604. Otherwise the process stays at S600. In S604, the server 30 searches for a route with reference to the external map DB 430, transmits the result of the route search to the communication terminal 20 or the like that is used for accessing the server 30 by the user, and presents information to the user as illustrated in FIG. 21 (S608). The user confirms the result of the route search. When an instruction for transmission to the vehicle is received, for example, a “transmit to vehicle” button in FIG. 21 is selected (S612), the external-map mode data is generated in subsequent S616. If a plurality of routes are calculated, one of the routes may be selected by the user. In subsequent S620, the server 30 waits for coupling from the in-vehicle terminal 10. In subsequent S624, the external-map mode data generated in S616 is transmitted to the in-vehicle terminal 10, completing the processing of FIG. 9.

As depicted in FIG. 10, the in-vehicle terminal 10 inquires of the user about a search operation mode at power-on (S640). In subsequent S642, if the in-vehicle terminal 10 determines that the user has selected an external map mode, the process advances to S644. If the in-vehicle terminal 10 determines that the external map mode has not been selected, that is, an in-vehicle terminal mode has been selected, the process advances to S676. In S644, the in-vehicle terminal 10 is coupled to the server 30 and receives the external-map mode data (S648). The in-vehicle terminal 10 then causes the external-map-mode search unit 530 to make a search by using the external-map mode data (S652).

Subsequently, the in-vehicle terminal 10 the search result of S652 to the map drawing unit 552, displays the route on the display 110 (S656), and transmits the search result of S652 to the guidance unit 554 so as to start route guidance (S660). Thereafter, the in-vehicle terminal 10 continues the guidance by the guidance unit 554 until Yes is confirmed in any one of S664, S668, and S672.

If the route deviation determination unit 562 determines a deviation from the route (S664: YES), a destination determined by the in-vehicle terminal 10 is changed by the user by means of the destination setting unit 558 (S668: YES), or the destination arrival determination unit 560 detects arrival at the destination without a deviation from the route searched for by the external-map-mode search unit 530 (S672: YES), the in-vehicle terminal 10 changes the external map mode is changed to the in-vehicle terminal mode (S676).

According to the first embodiment, the following effects can be obtained.

(1) A method of transmitting the external-map mode data by the server 30 includes: calculating the driving route of the vehicle from an origin to a destination by using the external-map search unit 420; extracting combinations of latitudes and longitudes, that is, route characteristic points from the driving route of the vehicle 40, that is, the calculation result of the external-map search unit 420 by using the external-map-mode data generation unit 440; and transmitting the external-map mode data, which includes the extracted combinations of latitudes and longitudes, to the vehicle 40 by using the server communication unit 490. Thus, even if the route searching method of the server 30 is different from that of the in-vehicle terminal 10, the replication of the route searched for by the server 30 can be improved in the in-vehicle terminal 10.

In the in-vehicle terminal 10, a route search to a destination by using information with small scales, for example, the M4 tier results in searches for various routes to the destination according to minute road information. This increases a search time. In order to avoid this problem, an ordinary navigation system uses a map with small scales only around the position of the vehicle and uses a rough map with large scales, for example, information on the M1 tier or the M2 tier for other parts, thereby shorting a search time. Thus, if the server 30 transmits only an origin and a destination to the in-vehicle terminal 10, different route searching methods may cause the server 30 and the in-vehicle terminal 10 to calculate different routes, resulting in poor replication.

In the present embodiment, the server 30 transmits combinations of latitudes and longitudes at a plurality of points on a calculated route as the external-map mode data. Thus, the in-vehicle terminal 10 calculates a route from an origin to a destination via the points, thereby calculating a route similar to a route searched for by the server 30, in other words, a route with high replication. Hence, if the user is familiar with a route search using the server 30, navigation using a satisfactorily replicated route can be provided for the result of the familiar route search.

(2) The vehicle 40 has the map DB 550 divided into a plurality of geographical areas. The server 30 extracts combinations of latitudes and longitudes that are equivalent to the intersection points of the boundaries of the geographical areas, that is, mesh boundaries in FIG. 7 and the calculated driving route P. Thus, the server 30 can provide information on the positions of via points that can be efficiently searched for by the in-vehicle terminal 10, as the external-map mode data. If latitudes and longitudes in the external-map mode data do not agree with the mesh boundaries, the calculation of a route between via points requires multiple pieces of map information or increases the number of searches, disadvantageously extending a total computing time.

(3) The vehicle 40 has the map DB 550 divided into meshes with a plurality of tiers, for example, the M1 tier to M4 tier. The server 30 extracts combinations of latitudes and longitudes that are equivalent to the intersection points of the division positions of the M4 tier, which is divided into a minimum area among the tiers, that is, the mesh positions of the minimum mesh M and the calculated driving route P. Thus, the server 30 can provide combinations of latitudes and longitudes as the external-map mode data such that the in-vehicle terminal 10 can efficiently calculate a detailed route.

(4) The route information transmission system S includes the server 30 and the in-vehicle terminal 10 that is installed in the vehicle 40 and communicates with the server 30. The server 30 includes the external-map search unit 420 that calculates the driving route of the vehicle from an origin to a destination, the external-map-mode data generation unit 440 that generates the external-map mode data including combinations of latitudes and longitudes from the driving route P calculated by the external-map search unit 420, and the server communication unit 490 that transmits the external-map mode data to the in-vehicle terminal. The in-vehicle terminal 10 includes the communication unit 590 that receives the external-map mode data and the external-map-mode search unit 530 that calculates a route from an origin to a destination via a plurality of points specified by combinations of latitudes and longitudes in the external-map mode data. Thus, even if the route searching method of the server 30 is different from that of the in-vehicle terminal 10, the replication of the route searched for by the server 30 can be improved in the in-vehicle terminal 10. Moreover, the in-vehicle terminal 10 receives combinations of latitudes and longitudes in the external-map mode data as the coordinates of via points, thereby shortening a search distance and a processing time for a route search.

(5) The in-vehicle terminal 10 installed in the vehicle 40 receives combinations of latitudes and longitudes that are transmitted by the server 30 according to the method. The in-vehicle terminal 10 includes the auxiliary storage device 112 that stores the map DB 550 used for a route search and the external-map-mode search unit 530 that refers to the map DB 550 and calculates a route from an origin to a destination via a plurality of points specified by combinations of latitudes and longitudes. Thus, even if the route calculation method of the in-vehicle terminal 10 is different from that of the server 30, a route can be calculated with high replication for a route calculated by the server 30.

(6) Multiple pieces of map information are stored with different scales in the map DB 550. The external-map-mode search unit 530 calculates a route by using the most detailed map information among the pieces of map information, that is, the M4 tier map illustrated in FIG. 7. Thus, the in-vehicle terminal 10 calculates detailed routes including a narrow street, thereby improving the replication of the route calculated by the server 30.

(7) The in-vehicle terminal 10 includes the in-vehicle terminal mode search unit 540 that calculates a route from an origin to a destination without referring to combinations of latitudes and longitudes and the navigation-mode determination unit 520 that determines, based on a user instruction, which one of the external-map-mode search unit 530 and the in-vehicle terminal mode search unit 540 is to be used for calculating a route. Thus, the in-vehicle terminal 10 can calculate a proper route in response to a request from the user.

(Modification 1)

In the first embodiment, the external-map-mode data generation unit 440 determined the route characteristic points based on the boundaries of the M4 tier map, that is, the minimum mesh M. However, the external-map-mode data generation unit 440 may determine the route characteristic points based on an angle at which the traveling direction changes, that is, the steering angle of the traveling vehicle.

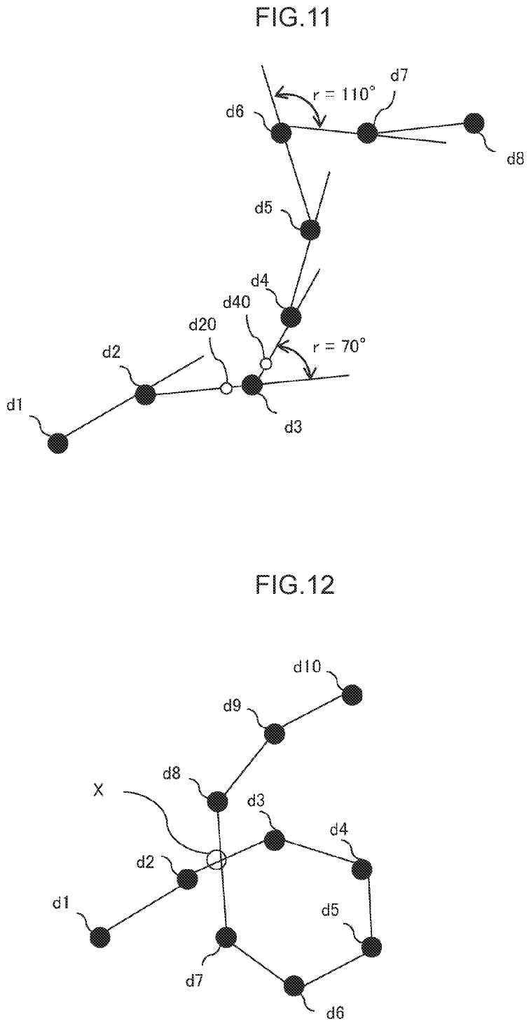

FIG. 11 is an explanatory drawing of the operation of the external-map-mode data generation unit 440 according to modification 1. In FIG. 11, straight lines indicate a route including a plurality of links searched for by the external-map search unit 420 and black dots d1 to d8 indicate the ends of the links, that is, nodes. The external-map-mode data generation unit 440 calculates an angular difference between the links on the route searched for by the external-map search unit 420 and selects the dot where the difference exceeds a threshold value, in other words, the dot where a large turn is made to the right or left. For example, if the threshold value is 60°, d3 with an angular difference of 70° and d6 with an angular difference of 1100 are selected in the example of FIG. 11. Moreover, in addition to the selected dots, combinations of latitudes and longitudes around the selected dots on the determined route are extracted.

If the route characteristic points are represented as nodes, the external-map-mode data generation unit 440 sets the coordinates of the nodes d2 to d4 as route characteristic points in order to indicate the node d3 and sets the coordinates of the nodes d5 to d7 as route characteristic points in order to indicate the node d6. However, the external-map-mode data generation unit 440 may use points other than the nodes. For example, the coordinates of d20 and d40 around the node d3 on the route determined to indicate the node d3 may be used as route characteristic points. Any distance, for example, 1 m or 2 m may be set between the nodes d3 and d20. In this case, the coordinates of the node d3 may not be included in the route characteristic points.

Modification 1 can obtain the following effect.

(8) The server 30 extracts combinations of latitudes and longitudes that are equivalent to points around a position where the traveling direction is changed by a predetermined angle or more during a movement on the calculated driving route, the points being located on the calculated driving route. Thus, the server 30 can provide the in-vehicle terminal 10 with information that can reliably replicate a point where the traveling direction is considerably changed.

In modification 1, the external-map mode data may include the route characteristic points in addition to the route characteristic points of the first embodiment or the external-map mode data may include only the route characteristic points without the route characteristic points of the first embodiment.

(Modification 2)

If the search result of the external-map search unit 420 is a route including a loop, the route characteristic points of the first embodiment may include coordinates constituting the loop such that the in-vehicle terminal 10 can calculate the route including the loop. For example, the external-map search unit 420 can determine the presence of a loop by detecting the intersections of links constituting a determined route. In other words, the external-map search unit 420 can determine the presence of a loop by determining the presence or absence of the intersection points of determined routes.

FIG. 12 is an explanatory drawing of the operation of the external-map-mode data generation unit 440 according to modification 2. In FIG. 12, straight lines indicate a route constituting a plurality of links searched for by the external-map search unit 420 and black dots d1 to d10 indicate the ends of the links, that is, nodes. The external-map-mode data generation unit 440 confirms the presence or absence of intersection for each of the links. The confirmation is made according to, for example, existing line segment intersection determination. When detecting an intersection point of line segments, that is, the presence of symbol X in FIG. 12, the external-map-mode data generation unit 440 selects at least one of d3 to d7 constituting a loop, as a route characteristic point. The external-map-mode data generation unit 440 may select a point other than a node as a route characteristic point.

Modification 2 can obtain the following effect.

(9) If it is determined that a calculated driving route intersects another calculated driving route so as to form a loop, the server 30 extracts combinations of latitudes and longitudes equivalent to points on the driving route and points in the loop. Thus, in the in-vehicle terminal 10 having received external-map mode data, the replication of the loop included in the route calculated by the server 30 improves. Since the presence or absence of the loop is noticeable as a difference between the routes, the replication of the loop is important.

### Second Embodiment

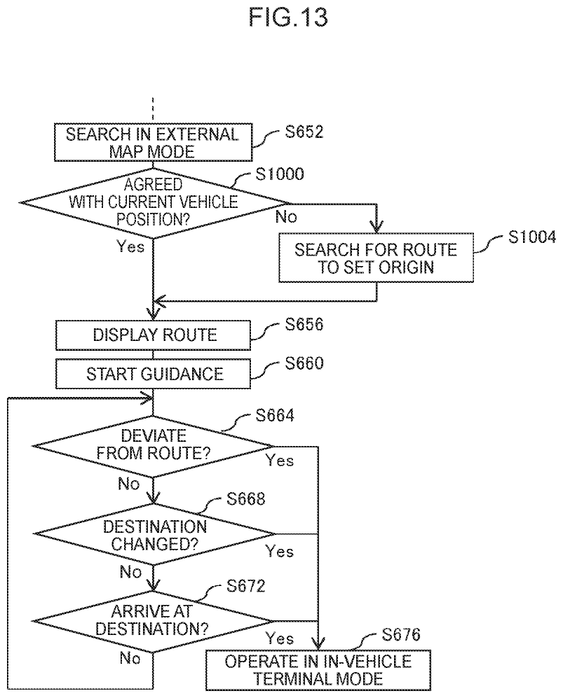

Referring to FIG. 13, a second embodiment of the route information transmission system of the present invention will be described below. The same constituent elements as those of the first embodiment are indicated by the same reference numerals and differences will be mainly described below. Points not particularly specified are identical to those of the first embodiment. The present embodiment is mainly different from the first embodiment in guidance by an in-vehicle terminal to an origin of external-map mode data.

A route information transmission system S is identical in configuration to that of the first embodiment. The present embodiment is mainly different from the first embodiment in the operations of an in-vehicle terminal 10.

(Flowchart of In-Vehicle Terminal)

FIG. 13 is a flowchart showing the operations of a navigation unit 500 of the in-vehicle terminal 10 according to the second embodiment. The same processing as that of the first embodiment is indicated by the same step number and an explanation thereof is omitted. In the present embodiment, processing is added between S652 and S656 of the first embodiment. In other words, processing until S652 and processing from S656 are similar to the processing of the first embodiment.

Subsequent to S652, the in-vehicle terminal 10 determines whether an origin in the external-map mode data and the current position of a vehicle 40 agree with each other (S1000). If an agreement is determined, the process advances to S656, otherwise the process advances to S1004. In S1004, the in-vehicle terminal 10 searches for a route from the current position of the vehicle 40 to the origin of the external-map mode data. Alternatively, from among multiple route characteristic points included in the external-map mode data, the in-vehicle terminal 10 may select the route characteristic point closest to the current position of the vehicle 40 and search for a route from the current position of the vehicle to the route characteristic point.

According to the second embodiment, the following effects can be obtained.

(10) The in-vehicle terminal 10 includes a vehicle position estimation unit 556 that estimates the position of the vehicle as a current position. If the current position is different from an origin, an external-map-mode search unit 530 specifies a combination of a latitude and a longitude closest to the current position from among combinations of latitudes and longitudes and calculates a route from the current position to the specified combination of the latitude and the longitude that are specified from the current position. Thus, even if an origin recorded in the external-map mode data is different from the current position of the vehicle 40, a route included in the external-map mode data can be used.

### Third Embodiment

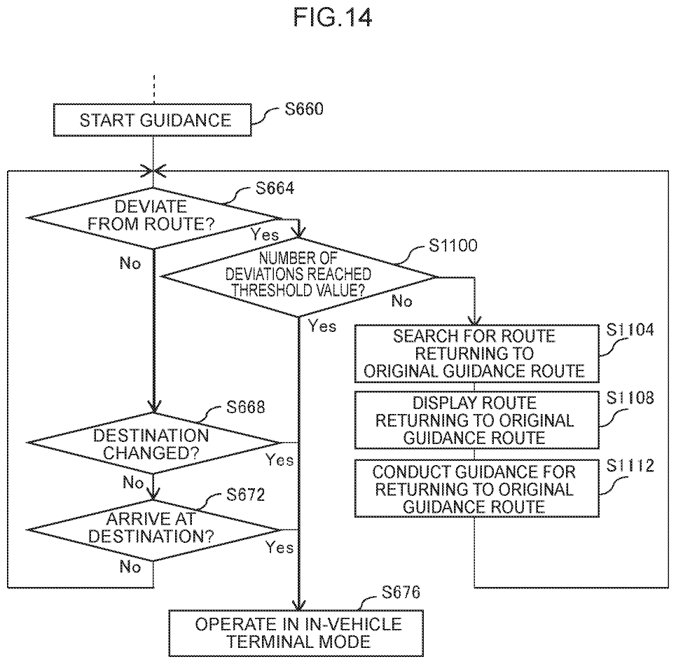

Referring to FIG. 14, a third embodiment of the route information transmission system of the present invention will be described below. The same constituent elements as those of the first embodiment are indicated by the same reference numerals and differences will be mainly described below. Points not particularly specified are identical to those of the first embodiment. The present embodiment is mainly different from the first embodiment in the handling of route deviation of an in-vehicle terminal 10.

A route information transmission system S is identical in configuration to that of the first embodiment. In the present embodiment, the in-vehicle terminal 10 has a threshold value for the number of route deviations determined by a route deviation determination unit 562 and provides guidance so as to return to an original route until the number of deviations reaches the threshold value, the original route being searched for by an external-map-mode search unit 530.

(Flowchart of In-Vehicle Terminal 10)

FIG. 14 is a flowchart showing the operations of a navigation unit 500 of the in-vehicle terminal 10 according to the third embodiment. The same processing as that of the first embodiment is indicated by the same step number and an explanation thereof is omitted. In the present embodiment, processing until S660 is similar to that of the first embodiment. When Yes is confirmed in S664 performed subsequent to S660, the in-vehicle terminal 10 does not immediately advance to S676 but to S1100 in the present embodiment. In S1100, the in-vehicle terminal 10 determines whether the number of deviations has reached the threshold value. If it is determined that the number of deviations has not reached the threshold value, the process advances to S1104. In S1104, the in-vehicle terminal 10 then causes the external-map-mode search unit 530 to search for a route returning to an original route searched for by the external-map-mode search unit 530 (S1108, S1112). When Yes is confirmed in S1100, the in-vehicle terminal 10 determines that a user has intentionally deviated from the route, and shifts to an operation in an in-vehicle terminal mode (S676).

According to the third embodiment, the following effects can be obtained.

(11) The in-vehicle terminal 10 includes a guidance unit 554 that provides guidance for a driver of the vehicle by using routes calculated by the external-map-mode search unit 530 and an in-vehicle terminal mode search unit 540. In guidance using the route calculated by the external-map-mode search unit 530, a navigation-mode determination unit 520 determines that a route is to be calculated by using the in-vehicle terminal mode search unit 540 when the number of deviations of the vehicle from the route used for the guidance exceeds a predetermined number of times. Thus, if the number of deviations falls below the predetermined number of times, it is determined that a route deviation is unintentionally made by a user, and then the vehicle is returned to an original route, that is, a route generated based on external-map mode data. Furthermore, if the number of deviations is equal to or larger than the predetermined number of times, it is determined that a route deviation is intentionally made by the user, and then the in-vehicle terminal mode search unit 540 is used. This can cancel the presentation of the route generated based on the external-map mode data.

### Fourth Embodiment

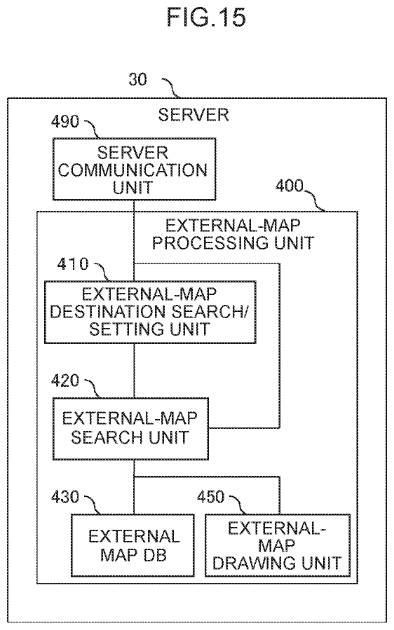

Referring to FIGS. 15 to 17, a fourth embodiment of the route information transmission system of the present invention will be described below. The same constituent elements as those of the first embodiment are indicated by the same reference numerals and differences will be mainly described below. Points not particularly specified are identical to those of the first embodiment. The present embodiment is mainly different from the first embodiment in that an external-map-mode data generation unit is provided for an in-vehicle terminal 10.

(Functional Configuration)

FIG. 15 illustrates the functional configuration of a server 30 according to the fourth embodiment. Unlike in FIG. 5 of the first embodiment, an external-map-mode data generation unit 440 and in-vehicle terminal map information 460 are omitted. The server 30 transmits the output result of an external-map search unit 420 as it is to the in-vehicle terminal 10.

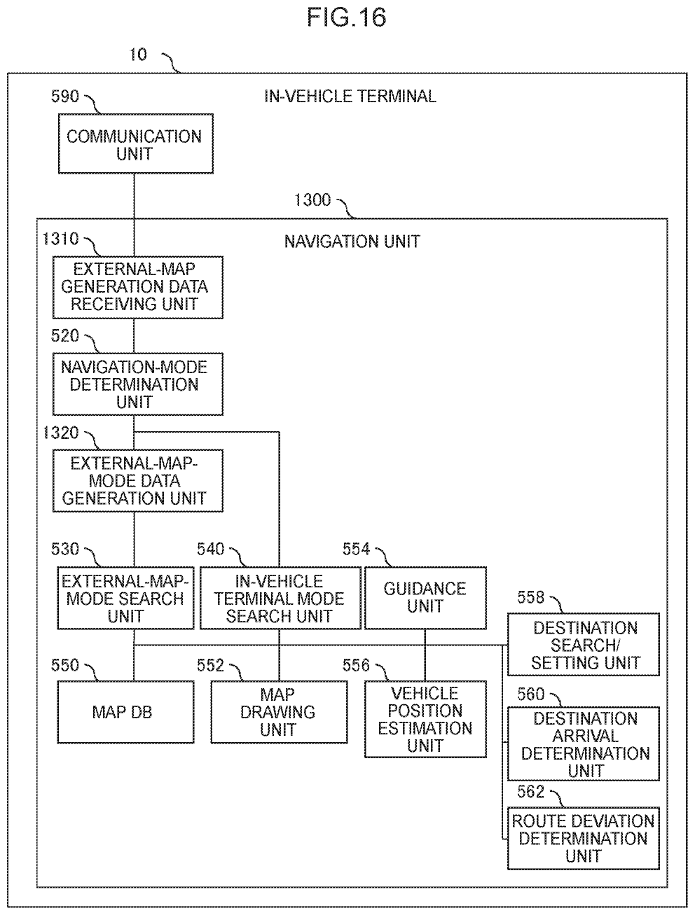

FIG. 16 illustrates the functional configuration of the in-vehicle terminal 10 according to the fourth embodiment. Unlike in FIG. 6 of the first embodiment, an external-map-mode data receiving unit 510 is replaced with an external-map generation data receiving unit 1310 and an external-map-mode data generation unit 1320 is added. The external-map-mode data generation unit 1320 has the functions of the external-map-mode data receiving unit 510 and the external-map-mode data generation unit 440 of the first embodiment.

Moreover, the in-vehicle terminal 10 may independently include information corresponding to the in-vehicle terminal map information 460 of the first embodiment or extract information corresponding to the in-vehicle terminal map information 460 from a map DB 550. If an external map DB 430 is necessary for interpreting the output result of the external-map search unit 420, for example, if the output result of the external-map search unit 420 includes the link number of the external map DB 430, the external map DB 430 is further stored in the in-vehicle terminal 10.

(Flowchart of Server 30)

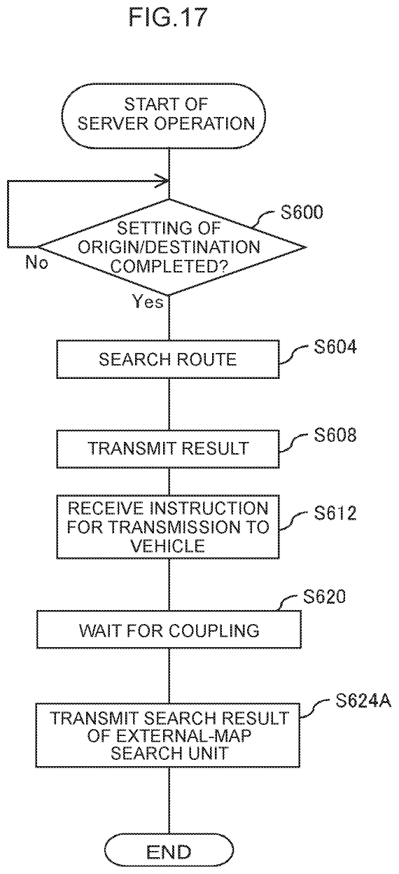

FIG. 17 is a flowchart showing the operations of an external-map processing unit 400 of the server 30 according to the fourth embodiment. The flowchart is different from that in FIG. 9 of the first embodiment in that S616 is omitted and S624A is performed instead of S624. In S624A, the server 30 transmits the output result of the external-map search unit 420 to the in-vehicle terminal 10.

(Flowchart of In-Vehicle Terminal 10)

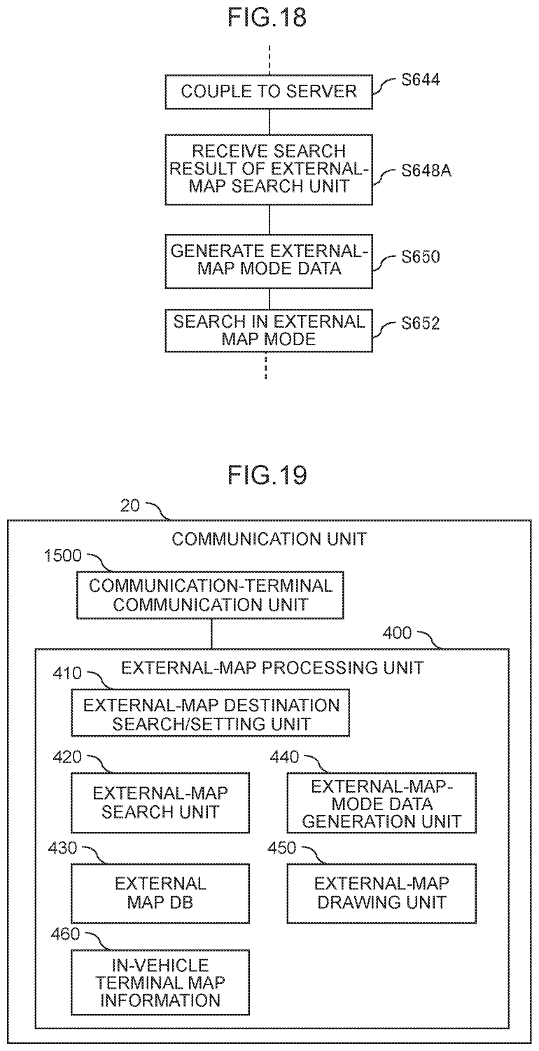

FIG. 18 is a flowchart showing the operations of a navigation unit 500 of the in-vehicle terminal 10 according to the fourth embodiment. The flowchart is different from that in FIG. 10 of the first embodiment in that S648A is performed instead of S648 and then S650 is performed. Processing from S650 is similar to that of the first embodiment. In S648A, the in-vehicle terminal 10 receives the search result of the external-map search unit 420 from the server 30. In S650 subsequent to S648A, the in-vehicle terminal 10 generates external-map mode data by using the search result of the external-map search unit 420, the search result being received in S648A.

According to the fourth embodiment, the processing load of the server 30 can be reduced.

### Fifth Embodiment

Referring to FIG. 19, a fifth embodiment of the route information transmission system of the present invention will be described below. The same constituent elements as those of the first embodiment are indicated by the same reference numerals and differences will be mainly described below. Points not particularly specified are identical to those of the first embodiment. The present embodiment is mainly different from the first embodiment in that an external-map-mode data generation unit is provided for a communication terminal 20.

FIG. 19 is a functional block diagram of the communication terminal 20 according to the fifth embodiment. As illustrated in FIG. 19, the communication terminal 20 of the fifth embodiment has all the functional configurations of the server 30 illustrated in FIG. 5 of the first embodiment. In the present embodiment, the communication terminal 20 may not include a communication module 232 as a hardware configuration. A communication-terminal communication unit 1500 in FIG. 19 is implemented by a machine-to-machine communication apparatus 231. In the present embodiment, an external-map processing unit 400 is implemented by developing and executing a program, which is stored in a ROM 201, on a RAM 202 by means of a CPU 200 of the communication terminal 20.

The external-map processing unit 400 operates as described with reference to FIG. 9 according to the first embodiment. The configuration and operations of an in-vehicle terminal 10 are similar to those of the first embodiment. However, a navigation unit 500 of the in-vehicle terminal 10 communicates with the communication terminal 20 instead of a server 30.

According to the fifth embodiment, the same effects can be obtained as the first embodiment even if the server 30 is not provided or a vehicle 40 is located at a point where the vehicle 40 cannot communicate with the server 30.

### Sixth Embodiment

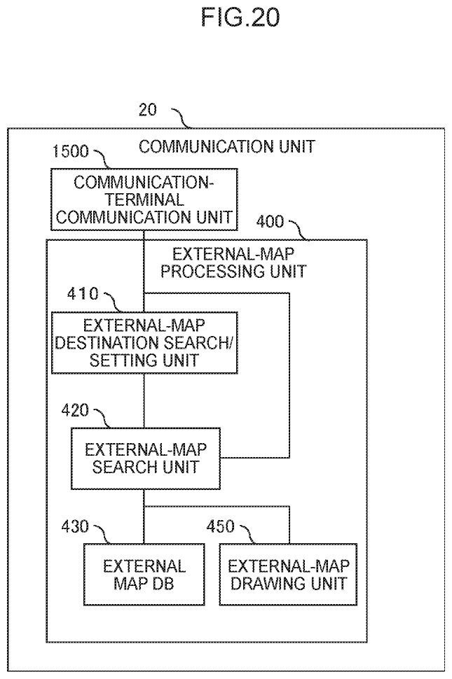

Referring to FIG. 20, a sixth embodiment of the route information transmission system of the present invention will be described below. The same constituent elements as those of the first embodiment are indicated by the same reference numerals and differences will be mainly described below. Points not particularly specified are identical to those of the first embodiment. The sixth embodiment is similar to the fourth embodiment. The relationship between the first embodiment and the fourth embodiment is identical to the relationship between the fifth embodiment and the sixth embodiment. Specifically, the external-map processing unit 400 provided in the communication terminal 20 according to the fifth embodiment is provided in an in-vehicle terminal 10 according to the sixth embodiment.

FIG. 20 is a functional block diagram of the communication terminal 20 according to the sixth embodiment. An external-map-mode data generation unit 440 and in-vehicle terminal map information 460 are omitted from the configuration illustrated in FIG. 19 according to the fifth embodiment. The external-map processing unit 400 transmits the output result of an external-map search unit 420 as it is to the in-vehicle terminal 10. The external-map processing unit 400 operates as described with reference to FIG. 17 according to the fourth embodiment. The functional configuration and operations of the in-vehicle terminal 10 are similar to those of the fourth embodiment and thus an explanation thereof is omitted.

According to the sixth embodiment, the same effects can be obtained as the first embodiment and the processing load of a communication terminal 20 can be reduced even if a server 30 is not provided or a vehicle 40 is located at a point where the vehicle 40 cannot communicate with the server 30.

In the foregoing embodiments and modifications, the program is stored in the in-vehicle terminal 10 or the ROM of the server 30. The program may be stored in an auxiliary storage device. Alternatively, the in-vehicle terminal 10 or the server 30 may include an input/output interface, which is not illustrated, and the program may be read from other devices through a medium readable by the input/output interface and the in-vehicle terminal 10 or the server 30 when necessary. The medium means, for example, a storage medium removable from the input/output interface, a communication medium, that is, a wired, wireless, or optical network, or a carrier wave or a digital signal that propagates through the network. Some or all of the functions implemented by the program may be implemented by a hardware circuit or an FPGA.

The foregoing embodiments and modifications may be combined. The present invention is not limited to the contents of the embodiments and modifications. Other modes within the scope of the technical idea of the present invention are also included in the scope of the present invention.

The disclosure of the following priority application is herein incorporated by reference:

Japanese Patent Application No. 2018-40035 (filed Mar. 6, 2018)

### REFERENCE SIGNS LIST

10 In-vehicle terminal
20 Communication terminal
30 Server
40 Vehicle
312 Auxiliary storage device
332 Server communication apparatus
400 External-map processing unit
410 External-map destination setting unit
420 External-map search unit
430 External map database
440 External-map-mode data generation unit
450 External-map drawing unit
460 In-vehicle terminal map information
490 Server communication unit
500 Navigation unit
510 External-map-mode data receiving unit
520 Navigation-mode determination unit
530 External-map-mode search unit
540 In-vehicle terminal mode search unit
550 Map database
552 Map drawing unit
554 Guidance unit
556 Vehicle position estimation unit
558 Destination setting unit
560 Destination arrival determination unit
562 Route deviation determination unit

1. A route information transmission method performed by a server,
the method comprising:
calculating a driving route of a vehicle from an origin to a destination;
extracting combinations of latitudes and longitudes from the calculated driving route; and
transmitting information on the extracted combinations of latitudes and longitudes to an in-vehicle terminal that is installed in the vehicle and searches for a route based on the combinations of latitudes and longitudes.

2. The route information transmission method according to claim 1, wherein
the in-vehicle terminal has map information divided into a plurality of geographical areas, and
the server extracts combinations of latitudes and longitudes that are equivalent to intersection points of boundaries of the geographical areas and the calculated driving route.

3. The route information transmission method according to claim 2, wherein
the in-vehicle terminal has map information divided into meshes with a plurality of tiers, and
the server extracts combinations of latitudes and longitudes that are equivalent to intersection points of division positions of the tier divided into a minimum area among the tiers and the calculated driving route.

4. The route information transmission method according to claim 1, wherein
the server extracts combinations of latitudes and longitudes that are equivalent to points around a position where a traveling direction is changed by a predetermined angle or more during a movement on the calculated driving route, the points being located on the calculated driving route.

5. The route information transmission method according to claim 1, wherein
if it is determined that the calculated driving route intersects another calculated driving route so as to form a loop, the server extracts combinations of latitudes and longitudes equivalent to points on the driving route and points in the loop.

6. A route information transmission system comprising a server and an in-vehicle terminal that is installed in a vehicle and communicates with the server,
the server including:
a map search unit that calculates a driving route of the vehicle from an origin to a destination;
an external-map-mode data generation unit that generates external-map mode data from the calculated driving route, the external-map mode data including combinations of latitudes and longitudes; and
a server communication unit that transmits the external-map mode data to the in-vehicle terminal,
the in-vehicle terminal including:
a communication unit that receives the external-map mode data; and
an external-map-mode search unit that calculates a route from the origin to the destination via a plurality of points specified by the combinations of latitudes and longitudes in the external-map mode data.

7. An in-vehicle terminal that is installed in a vehicle and receives information on combinations of latitudes and longitudes,
the in-vehicle terminal including:
a storage unit that stores a map database used for a route search; and
an external-map-mode search unit that calculates, with reference to the map database, a route from the origin to the destination via a plurality of points specified by the combinations of latitudes and longitudes that are indicated by the received information.

8. The in-vehicle terminal according to claim 7, wherein
multiple pieces of map information are stored with different scales in the map database, and
the external-map-mode search unit calculates a route by using most detailed map information among the pieces of map information.

9. The in-vehicle terminal according to claim 7, further comprising:
an in-vehicle terminal mode search unit that calculates a route from the origin to the destination without referring to the combinations of latitudes and longitudes; and
a navigation-mode determination unit that determines, based on a user instruction, which one of the external-map-mode search unit and the in-vehicle terminal mode search unit is to be used for calculating the route.

10. The in-vehicle terminal according to claim 7, further comprising:
a vehicle position estimation unit that estimates a position of the vehicle as a current position, wherein
if the current position is different from the origin, the external-map-mode search unit specifies a combination of a latitude and a longitude closest to the current position from among the combinations of latitudes and longitudes and further calculates a route from the current position to the specified combination of the latitude and the longitude that are specified from the current position.

11. The in-vehicle terminal according to claim 9, further comprising:
a guidance unit that provides guidance for a driver of the vehicle by using routes calculated by the external-map-mode search unit and the in-vehicle terminal mode search unit, wherein
in guidance using the route calculated by the external-map-mode search unit, the navigation-mode determination unit determines that a route is to be calculated by using the in-vehicle terminal mode search unit when the number of deviations of the vehicle from the route used for the guidance exceeds a predetermined number of times.
